(19) United States
(12) Patent Application Publication
(10) Pub. No.: US 2019/0061762 A1
(43) Pub. Date: Feb. 28, 2019

(54) METHOD FOR OPERATING A MOTOR VEHICLE

(71) Applicant: ZF FRIEDRICHSHAFEN AG, Friedrichshafen (DE)

(72) Inventors: Stefan BEMETZ, Wangen im Allgäu (DE); Roland MAIR, Tettnang (DE); Achim CHIANDETTI, Friedrichshafen (DE); Thomas JÄGER, Meckenbeuren (DE)

(21) Appl. No.: 16/064,117

(22) PCT Filed: Nov. 22, 2016
(86) PCT No.: PCT/EP2016/078439

§ 371 Date: Oct. 30, 2018

(30) Foreign Application Priority Data
Dec. 21, 2015 (DE) 10 2015 226 130.1

(51) Int. Cl. B60W 30/18; B60W 50/16

(52) U.S. Cl. CPC B60W 30/18063; B60W 2050/0095; B60W 50/16

(57) ABSTRACT

A method for controlling a creep mode of a motor vehicle with a drive train having a drive unit (1), a transmission (2) and a friction clutch (4) which is disposed between the drive unit (1) and the transmission (2). A creep function for controlling the creep mode may be activated if the drive unit (1) is operating, if a suitable gear is selected in transmission (2) and if an accelerator pedal (14) is not depressed. The creep function is activated at a depressed brake pedal (15) if a current brake pedal position or a current brake pressure respectively reaches or is less than a predetermined motion-resistance-dependent threshold value of the brake pedal position or the brake pressure, respectively.

This application is a National Stage completion of PCT/EP2016/078439 filed Nov. 22, 2016, which claims priority from German patent application serial no. 10 2015 226 130.1 filed Dec. 21, 2015.

### FIELD OF THE INVENTION

The invention concerns a method for controlling a creep mode of a motor vehicle. Moreover, the invention concerns a control device that is designed to implement the method, including a corresponding computer software product.

### BACKGROUND OF THE INVENTION

In motor vehicles with automatic transmissions it is known to provide a creep function, which has the purpose of controlling a motor vehicle in a creep mode, in which the motor vehicle carries out a creep motion at low vehicle speed. The creep mode advantageously enables comfortable parking or starting respectively of a motor vehicle.

When the creep function is activated, a creep torque is transmitted via a friction clutch, disposed between a drive unit and an automatic transmission, wherein the provided amount of creep torque is such that the motor vehicle is only able to carry out a creep motion at low speed but not a normal drive motion. Depending on the gear engaged at the time, the creeping of the vehicle may take place in forward as well as reverse direction and support the driver during start-up or in maneuvering the vehicle.

It is known, for example, from DE 10 2006 037 836 A1 that the creep torque is set at the clutch, that is, the creep function is activated as soon as the conditions for creeping are met, in particular that the drive unit is in operation, a starting gear has been selected and neither the accelerator pedal nor the brake pedal are operated.

### SUMMARY OF THE INVENTION

Based upon the above described prior art it is the object of the present invention to provide a new method for controlling a creep mode of a motor vehicle, which enables sensitive driving at low vehicle speed and low clutch wear. Moreover, a corresponding control device that is designed to implement the method and a computer software product for the implementation of the method are provided.

From a process technology point of view this objective is met based upon the characterizing features of the independent claims. Moreover, a control device for controlling a creep mode of a motor vehicle is described below together with the computer software product. Advantageous further developments are subject of the dependent claims as well as the following description.

Proposed is a method for controlling a creep mode of a motor vehicle with a drive train, comprising a drive unit, a transmission and a friction clutch arranged between the drive unit and the transmission, wherein a creep function for controlling a creep mode may be activated provided that the drive unit is running, a suitable gear has been selected in the transmission and an accelerator pedal is not operated.

The transmission is preferably an automatic or an automated transmission respectively, which may be in form of an automated range change transmission, an automatic transmission, a dual clutch transmission, a continuously variable power split transmission etc. The transmission may also be comprised of a number of transmission groups, wherein a split group is disposed upstream or downstream of a main group and/or a range group is disposed downstream of a main group. The motor vehicle in which the method according to the invention has been applied is, for example, a commercial vehicle such as a truck.

The drive unit may be a combustion engine, an electrical drive or a hybrid drive, which comprises an electrical drive as well as a combustion engine.

The creep function may be selected manually by a driver or it may be activated automatically if the required conditions are present. A signal that indicates that the driver has requested an activation of the creep function may be generated, for example, if a driver operates a switch or push button.

The invention encompasses the technical teaching that a motion-resistance-dependent threshold value is determined for a brake pedal position or a brake pressure respectively and, with a depressed brake pedal, the creep function is activated if a current brake pedal position or a current brake pressure respectively reaches the motion-resistance-dependent threshold value or is below it.

In order to activate a creep function, a certain position or a degree of depression respectively of a brake pedal or a brake pressure is measured and compared with a motion-resistance-dependent threshold value. If, for example, the brake pedal is moved from a fully depressed position into a fully released position, a creep function is activated as soon as the motion-resistance-dependent threshold value is reached or is below it, provided that the other conditions required for the creep mode are also met.

In order to determine the motion-resistance-dependent threshold value, the motion resistance or the motion resistance torque has to be known. The motion resistance may be determined by methods that are well known to those skilled in the art under consideration of, for example, the mass of the vehicle and the incline of the roadway. The motion resistance torque results from the sum of the motion resistance components of the vehicle, such as the rolling resistance, gradient resistance and air resistance and may be obtained through recalculation under consideration of the overall gear ratio and the efficiency of the drive train on the transmission input shaft or the friction clutch respectively. The threshold value for the brake pedal operation is then determined from the known motion resistance or the motion resistance torque respectively.

When controlling the creep mode with the brake pedal depressed, it is possible to advantageously emulate a converter behavior that is known from an automatic transmission, wherein the brake pedal basically functions simultaneously as brake pedal as well as a clutch pedal. With an activated creep mode the friction clutch is controlled such that a creep torque is transmitted via the friction clutch, which is sufficiently high to overcome the motion resistance or motion resistance torque respectively that acts upon the motor vehicle. Provision is made in this instance that a creep torque, which is transmitted via the automated friction clutch, is influenced through the operation of the brake pedal as long as the current brake pedal position or the current brake pressure respectively does not again exceed the pre-set, motion-resistance-dependent threshold value. Thus, when operating the brake pedal inside a range between the motion-resistance-dependent threshold value and a not-depressed brake pedal position the friction clutch is engaged further when operating the brake pedal in the direction of a not-depressed brake pedal position, which increases the creep torque transmitted via the friction clutch, whereas when operating the brake pedal in the direction of the threshold value the friction clutch is disengaged further, which reduces the creep torque transmitted via the friction clutch. If the current brake pedal position or the current brake pressure respectively reaches or respectively exceeds the motion-resistance-dependent threshold value, the creep function is deactivated, the friction clutch is fully disengaged and the motor vehicle is held stationary due to the set brake pressure.

The smaller the actual motion resistance, the further the motion-resistance-dependent threshold value lies in the direction of “brake pedal fully depressed”. Hence the motion-resistance-dependent threshold value lies, for example, in an unloaded vehicle on a level surface further in the direction of “brake pedal fully depressed” than in a fully loaded vehicle resting on a gradient.

Thus an adjustment range of the brake pedal, which may be operated by the driver during an activated creep function, is larger if the motion resistance is low, and is smaller if the motion resistance is high. Since, through releasing of the brake pedal, the motion-resistance-dependent threshold value is reached later when the actual motion resistance is high, the creep mode begins later. However, a small change in the brake pedal position then causes the friction clutch to engage relatively quickly so that the torque transferred via the clutch increases rapidly. Thus the stress on the clutch and the consequential clutch wear of a friction clutch operated in slip during creep mode may be reduced.

Moreover, it may be provided that, for the activation of the creep function in addition a negative gradient of the brake pedal operation or a negative gradient of a brake pressure respectively is considered, wherein, dependent on this, a first or a second creep function may be activated.

Thus the first creep function for controlling the creep mode may be activated if the negative gradient of the brake pedal operation or the negative gradient of the brake pressure respectively is smaller than a pre-settable gradient threshold value, that is, a change in brake pedal position or brake pressure respectively in the direction of “brake pedal not depressed” only takes place slowly. The first creep function is then activated, in which the creep torque, which is transmitted via the automated friction clutch, may be influenced through operating the brake pedal.

In contrast, the second creep function for controlling the creep mode is activated if the negative gradient of the brake pedal operation or the negative gradient of the brake pressure respectively is greater or equal to a pre-settable gradient threshold value, that is, a change in brake pedal position or brake pressure respectively in the direction of “brake pedal not depressed” takes place quickly. Then a complete release of the brake pedal or the brake pressure respectively is expected and the second creep function is activated, in which the creep torque, which is transmitted via the automated friction clutch, is set when the brake pedal is not depressed.

A further condition for activating the creep function is to ascertain whether a transmission input speed is less than an engine idle speed; if the measured transmission input speed is above that of the engine idle speed, it is concluded that the vehicle speed is too great for the creep mode, and the activation of the creep function is prevented. Such a driving situation may, for example, occur if the vehicle rolls with a gear engaged in the transmission. The engaging of the friction clutch to a transmittable creep torque would apply great stress on the friction clutch and result in a correspondingly high degree of wear on the clutch.

Moreover, it may be provided to deactivate an activated creep function if the friction clutch has been operated in slip mode for longer than a predetermined time, if the vehicle has not moved within a predetermined time, if a maximum clutch torque has been reached or exceeded respectively, if no vehicle movement has been detected and/or a clutch loading has been reached or exceeded respectively. Due to the termination criteria, which may be considered individually or in combination, a thermal overload of the friction clutch and thus the resulting high level of wear of the friction clutch may be avoided. The deactivation of the creep function is also provided if the signals necessary for the implementation of the creep function are not present. Such signals may, for example, be the position signals of brake pedal and accelerator pedal.

If the deactivation of the creep function results in the disengaging of the friction clutch, it may be that the motor vehicle rolls backwards if the motor vehicle is situated on a gradient. If a backwards-rolling of the motor vehicle is detected when the friction clutch is disengaged, the locking of a service brake of the motor vehicle may be initiated to stop the motor vehicle. Alternatively it is possible, for example, to generate a jerking motion of the vehicle through a pulsed clutch operation, or a visual driver warning in the form of an indicator on a vehicle display or an acoustic driver warning in form of a warning sound is emitted so as to alert the driver to such a situation. The term backwards rolling is understood to mean the rolling of the motor vehicle in a direction opposite to a normal driving direction.

If the activated creep function was deactivated by one of the above-stated conditions, provision may be made that the creep function can be reactivated through a deliberate manual operation of a control element of the motor vehicle by a driver. The driver may, for example, change the drive mode selector into a neutral position and back into a drive mode position, or the driver may depress the brake pedal or the accelerator pedal respectively to activate the service brakes of the motor vehicle or to cause the motor vehicle to start up.

The invention concerns, furthermore, a control device that is designed to implement the method according to the invention. The control device comprises means that facilitate the implementation of the method according to the invention. The means include hardware means as well as software means. The hardware means include data interfaces to facilitate the exchange of data with the components of the drive train that are concerned with the implementation of the method according to the invention. The hardware means of the control device also include a data processor and, if necessary, a memory for data storage. The software means include program blocks for the implementation of the method according to the invention.

The control device for implementing the method according to the invention comprises at least one receiving interface, which is designed to receive at least one signal from a control element that indicates the driver's request for activating the creep function, a signal from a speed sensor that shows a state of the drive unit, a signal from a position sensor or a displacement sensor respectively which is used to conclude which gear is selected in the transmission, a signal from a position sensor or a displacement sensor respectively which is used to detect a position or an operation respectively of the accelerator pedal, as well as a signal from a position sensor or a displacement sensor respectively which is used to detect a position or an operation respectively of the brake pedal. The control device, moreover, comprises an analysis unit for assessing the received input signals or, respectively, the information contained in the received input signals. Based upon the received input signals or, respectively, the information contained in the received input signals, the control device determines whether the creep function may be activated and is requested by the driver. If the creep function can be activated and the motor vehicle is intended to be operated in creep mode, the creep function is activated by the control device. The control device issues control signals via a transmitting interface to drive train components so as to operate the motor vehicle in creep mode.

The control device may take the form of a central control unit or a transmission control unit. The above-named signals are understood to be examples only and are not intended to limit the invention. The acquired input signals and the emitted control signals may be transmitted via a vehicle bus, for example via a CAN bus.

The solution according to the invention may also be implemented as a computer program which, when it runs on a processor of a control unit, leads the processor via the software to implement the processing steps required by the invention. In this context a machine-readable medium is also part of the object of the invention, which stores an above-described computer program in a retrievable form.

The invention is not limited to the stated combination of characteristics of the subordinate claims or the claims dependent on them. Moreover, there are opportunities to combine individual characteristics that arise from the claims, from the following description of exemplary embodiments or directly from the drawings. The reference of the claims to the drawings through the use of reference numerals is not intended to limit the scope of protection of the claims.

### BRIEF DESCRIPTION OF THE DRAWINGS

Advantageous embodiments of the invention, which are described in detail below, are shown in the drawings. Depicted in:

FIG. 1 is a block diagram of a drive train with an automatic transmission, and

FIG. 2 is a flow diagram of a method according to the invention for controlling a creep mode of a motor vehicle.

### DETAILED DESCRIPTION OF THE DRAWINGS

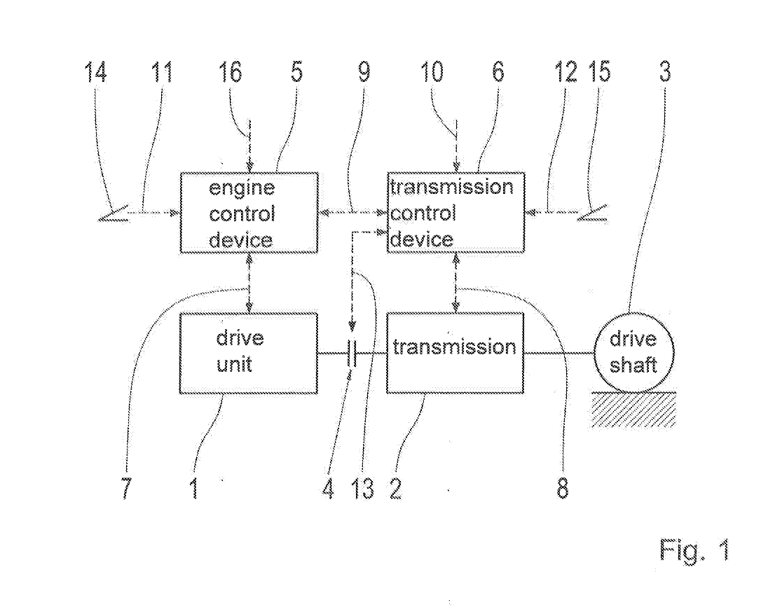

FIG. 1 depicts a highly schematic representation of a drive train of a motor vehicle, wherein the shown drive train comprises a drive unit 1 and a transmission 2, wherein the transmission 2 is disposed between the drive unit 1 and a drive shaft 3 of the drive train. The transmission 2 is preferably provided in the form of an automatic transmission or an automated transmission respectively, which converts the speed and torque of the drive unit 1 and thus makes the tractive force of the drive unit 1 available at the drive shaft 3. According to FIG. 1 a friction clutch 4 is disposed between the drive unit 1 and the transmission 2, wherein the friction clutch 4 takes the form of an automated shifting clutch or starting clutch respectively. An engine control device 5 is allocated to the drive unit 1 and a transmission control device 6 is allocated to the transmission 2. The operation of the drive unit 1 is controlled and/or regulated by way of the engine control device 5, for which purpose the drive unit 1 also exchanges data 7 with the engine control device 5. The operation of the transmission 2 is controlled and/or regulated by way of the transmission control device 6, for which purpose the transmission control device 6 also exchanges data 8 with the transmission 2. Moreover, according to FIG. 1 the engine control device 5 and the transmission control device 6 exchange data 9 between them. The operation of the friction clutch 4 is also controlled and/or regulated by the transmission control device 6, for which purpose the transmission control device 6 exchanges data 13 with the friction clutch 4. Alternatively it is possible that the operation of the friction clutch 4 is controlled and/or regulated by a friction clutch control device, which may then be able to exchange data with the friction clutch 4, the transmission control device 6 and the engine control device 5.

Moreover, the transmission control device 6 is provided with data 12 concerning the position or the degree of displacement respectively of a brake pedal 15, and the engine control device 5 is provided with data 11 concerning the position or the degree of displacement respectively of an accelerator pedal 14. The position or the degree of displacement respectively of the brake pedal 15 may be acquired by a displacement or position sensor respectively disposed on the brake pedal 15, and the position or the degree of displacement respectively of the accelerator pedal 14 may be acquired by a displacement or position sensor respectively disposed on the accelerator pedal 14.

According to FIG. 1, the transmission control device 6 is provided with data 10 that is acquired through further, not-depicted sensors, on the basis of which the transmission control device 6 controls and/or regulates the operation of the transmission 2 and the operation of the friction clutch 4. Moreover, the engine control device 5 is provided with data 16 that is acquired through further, not-depicted sensors, on the basis of which the engine control device 5 controls and/or regulates the operation of the drive unit 1.

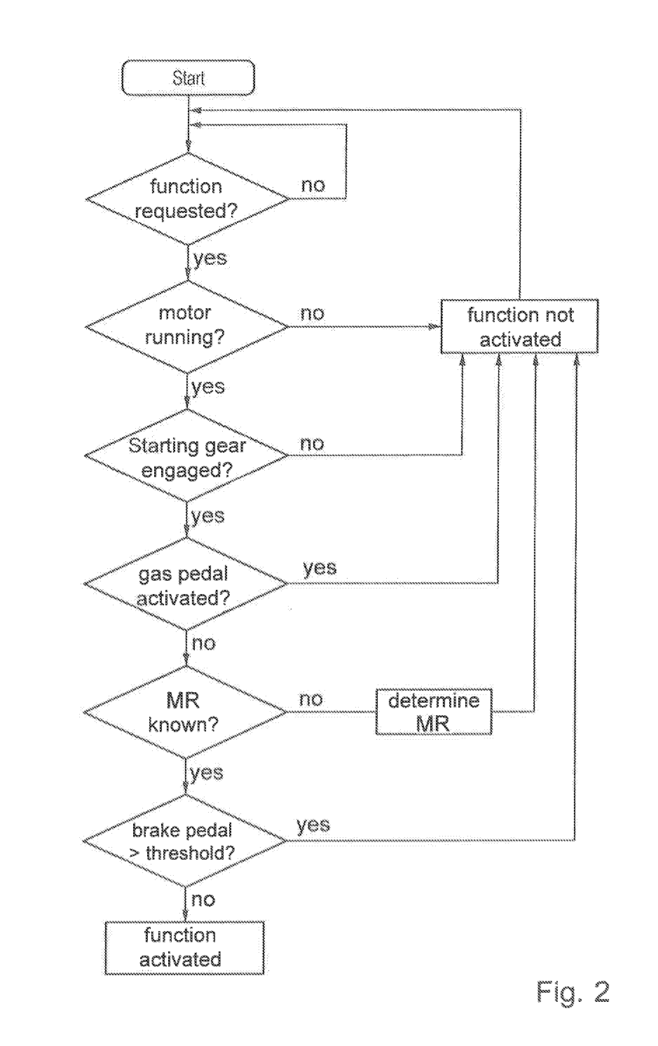

Provision is now made to permit the activation of a creep function if the position or the degree of displacement respectively of the brake pedal 15 reaches, or is less than, a threshold value that is dependent on the motion resistance. A control device, for example the transmission control device 6, now executes the process depicted in the flow diagram shown in FIG. 2, which will now be explained in greater detail by way of FIG. 2:

At the start of the process the motor vehicle is at a standstill. In a first step it is verified whether the creep function is requested by a driver. The driver may, for example, request the creep function by operating a switch or push button or via a menu selection on an on-board computer.

If it is confirmed that the creep function has been requested, the next process step is to verify whether the drive unit 1 runs. If the drive unit is recognized as not running, the creep function is not activated. If the drive unit 1 does run, it is verified as a further condition for the activation of the creep function whether a starting gear has been engaged in transmission 2. If transmission 2 is in a neutral position, the creep function is not activated, whereas if a starting gear has been selected the position of the accelerator pedal 14 is verified in a further process step. If the accelerator pedal 14 is in operation, the activation of the creep function is prevented since a depressed accelerator pedal 14 is considered to be a starting request by the driver. If, however, the accelerator pedal 14 is not depressed, the next process step verifies whether a current motion resistance (MR) is known. If the motion resistance (MR) is not known, the creep function is initially not activated and the motion resistance (MR) is calculated or estimated respectively through methods that are known to those skilled in the art. Since the air resistance is negligible on account of the motor vehicle standing still, the motion resistance can be established from the sum of the rolling resistance and the gradient resistance under consideration of the mass of the vehicle. A threshold value for a brake pedal operation is then determined from the known motion resistance value. The creep function is activated as soon as a current position of the brake pedal reaches or is less than the threshold value. If, however, the threshold value is not reached or it is not below said value, that is, the brake pedal is located somewhere in a range between a fully depressed brake pedal position and the motion resistance-dependent operating threshold, the creep function will not be activated. Once the creep function has been activated, a creep torque is transmitted via the friction clutch 4 and the motor vehicle carries out a creep motion at a low vehicle speed as a result.

### REFERENCE NUMERALS

1 Drive unit
2 Transmission
3 Drive shaft
4 Friction clutch
5 Engine control device
6 Transmission control device
7 Data
8 Data
9 Data
10 Data
11 Data
12 Data
13 Data
14 Accelerator pedal
15 Brake pedal
16 Data

1-11. (canceled)

12. A method for controlling a creep mode of a motor vehicle with a drive train comprising a drive unit (1), a transmission (2) and a friction clutch (4), which is disposed between the drive unit (1) and the transmission (2), wherein a creep function for controlling the creep mode may be activated when the drive unit (1) operates, a suitable gear is selected in transmission (2) and an accelerator pedal (14) is not depressed, the method comprising:
activating the creep function at a depressed brake pedal (15) if either a current brake pedal position or a current brake pressure, respectively, reaches or is less than a predetermined motion resistance-dependent threshold value of the brake pedal position or the brake pressure, respectively.

13. The method according to claim 12, further comprising, in order to activate the creep function, considering a negative gradient of the brake pedal displacement or a negative gradient of the brake pressure.

14. The method according to claim 13, further comprising activating a first creep function for controlling the creep mode if the negative gradient of the brake pedal displacement or the negative gradient of the brake pressure respectively is less than a predetermined gradient threshold value.

15. The method according to claim 13, further comprising activating a second creep function for controlling the creep mode if the negative gradient of the brake pedal displacement or the negative gradient of the brake pressure, respectively, is greater or equal to a predetermined gradient threshold value.

16. The method according to claim 12, further comprising, as a further condition for activating the creep function, verifying whether a transmission input speed is below an engine idle speed.

17. The method according to claim 12, further comprising deactivating the activated creep function if one of:
the current brake pedal position or the current brake pressure,
respectively, exceeds the predetermined, motion-resistance-dependent threshold value, the friction clutch (4) operates in slip mode for longer than a predeterminable time,
a vehicle motion is not registered after a predeterminable time,
a maximum clutch torque is reached or exceeded without registering a vehicle motion,
a load on the friction clutch reaches or exceeds a threshold value, and
signals that are required for implementing the creep function are not received.

18. The method according to claim 17, further comprising, when, due to the deactivated creep function the friction clutch (4) is disengaged and consequently reverse-rolling of the motor vehicle is detected, at least one of:
initiating engagement of a service brake of the motor vehicle,
generating a driver alert in a form of a pulsing movement of the clutch,
providing a visual driver alert in a form of an indicator on a driver display, or
emitting an acoustic driver alert in a form of a warning sound.

19. The method according to claim 17, wherein making the deactivated creep function available again if one of:
a drive mode selector is changed to neutral and back into a drive mode,
the service brake of the motor vehicle was operated, or
the motor vehicle was started up due to an accelerator operation.

20. A control device for controlling a creep mode of a motor vehicle comprising:
at least one receiving interface, which is designed to receive input signals from drive train components,
an analysis unit for processing either the received input signals or information respectively of the received input signals, and
a transmitting interface for sending control signals to the drive train components,
the control device being designed to activate a creep function to control the creep mode if, with a drive unit (1) operating, with a gear engaged in a transmission (2) and with the accelerator pedal (14) not operated, either a current brake pedal position or a current brake pressure respectively reaches or is respectively less than a predetermined motion-resistance-dependent threshold value of the brake pedal position or the brake pressure, respectively.

21. The control device according to claim 20, wherein the control device implements a method of controlling the creep mode of the motor vehicle with the drive train comprising the drive unit (1), the transmission (2) and a friction clutch (4) which is disposed between the drive unit (1) and the transmission (2), wherein the creep function for controlling the creep mode may be activated if the drive unit (1) is operating, a suitable gear is selected in transmission (2) and the accelerator pedal (14) is not depressed, the method comprising:
activating the creep function at a depressed brake pedal (15) if either the current brake pedal position or a current brake pressure, respectively, reaches or is less than the predetermined motion resistance-dependent threshold value of the brake pedal position or the brake pressure, respectively.

22. A computer software product with program code means, which are stored on a computer-readable storage medium and executed either on a computer or on a corresponding computing unit, in particular on a control device to implement all stages of a process for controlling a creep mode of a motor vehicle with a drive train comprising a drive unit (1), a transmission (2) and a friction clutch (4) which is disposed between the drive unit (1) and the transmission (2), wherein a creep function for controlling the creep mode may be activated if the drive unit (1) is operating, a suitable gear is selected in transmission (2) and an accelerator pedal (14) is not depressed, the process comprising activating the creep function at a depressed brake pedal (15) if either a current brake pedal position or a current brake pressure respectively reaches or is less than a predetermined motion resistance-dependent threshold value of the brake pedal position or the brake pressure, respectively.
